(19) United States
(12) Patent Application Publication
(10) Pub. No.: US 2012/0247503 A1
(43) Pub. Date: Oct. 4, 2012

(54) VEHICLE WITH PARTICULATE RESISTANT WINDSHIELD

(75) Inventor: David G. Strand, Aurora, IL (US)

(73) Assignee: International Truck Intellectual Property Company LLC, Lisle, IL (US)

(21) Appl. No.: 13/508,889

(22) PCT Filed: Nov. 24, 2009
(86) PCT No.: PCT/US09/65719

§ 371 Date: Jun. 8, 2012

(51) Int. Cl. B60J 1/00; B08B 7/00

(52) U.S. Cl. 134/1; 296/84.1

(57) ABSTRACT

A vehicle having a particulate resistant windshield comprises a windshield, an ionizer, and a controller. The windshield is disposed in a cab portion of a vehicle. The windshield has a periphery. The ionizer has at least one electrode disposed adjacent the periphery of the windshield. The controller is in electrical communication with the ionizer. The controller generates a signal transmitted to the ionizer to control generation of ions by the ionizer. The ions generated by the ionizer are directed towards at least a portion of the windshield.

### TECHNICAL FIELD

The present disclosure relates to a particulate resistant windshield system for a vehicle, and more particularly to a particulate resistant windshield system that utilizes ionization to reduce static adhesion of particulate to the windshield.

### BACKGROUND

Many vehicles used in certain settings, such as desserts or construction sites, or vehicles used in off-road settings may develop dirty windshields as particulate adheres to the windshields. As a vehicle moves through air while driving, a static charge may develop on the vehicle. The static charge on the vehicle may attract particulate to the vehicle, as the vehicle and particulate may have opposite electrical charges. In order to clean a windshield on such a vehicle, some windshield washer systems utilize a cleaning liquid in conjunction with windshield wipers to remove particulate from a windshield. In some cases, the vehicle may run out of cleaning liquid, and an operator may be unable to easily clean the windshield. It is possible that use of windshield wipers to reduce the particulate may cause the particulate to scratch the surface of the windshield, thereby limiting visibility from the vehicle, and necessitating repair.

A need exists for a windshield that resists particulate adhering to the windshield and helps to clean the windshield without the use of a liquid cleaner.

### SUMMARY

According to one embodiment, a windshield assembly comprises a windshield having a periphery, and an ionizer disposed adjacent the periphery of the windshield. The ionizer has at least one electrode that delivers ions over at least a portion of the windshield.

Another embodiment provides a method for reducing particulate accumulating on a windshield of a vehicle. According to this method, ions are generated with an ionizer having at least one electrode disposed adjacent a periphery of the windshield. The ions are directed from the ionizer to at least a portion of the windshield. Particulate adhered to at least the portion of the windshield are repelled with the ions.

### BRIEF DESCRIPTION OF THE DRAWINGS

FIG. 1 is a schematic view of a vehicle having a windshield assembly described herein.

### DETAILED DESCRIPTION

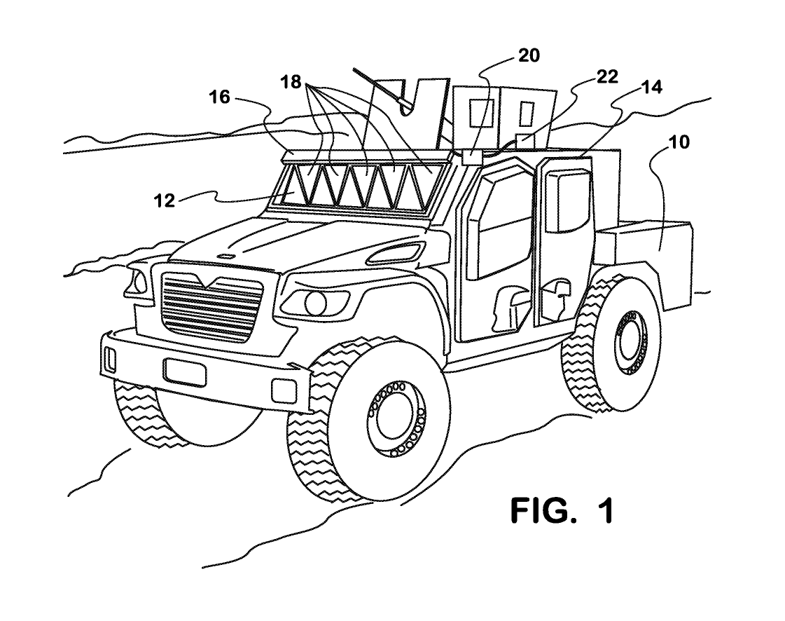

FIG. 1 shows a schematic view of a vehicle 10 including an embodiment of a windshield assembly described herein. The vehicle 10 has a windshield 12 located at a cab portion 14 of the vehicle 10. The windshield 12 may be formed from a variety of materials, such as safety glass, a laminate, a polymeric material and the like.

The windshield assembly includes an ionizer 16 mounted adjacent to a peripheral edge of the windshield 12. One example of an ionizer 16 that may be used with the embodiment of FIG. 1 is a 1525 or Model 1526 Pulsed DC bars manufactured by Cole Static Control, Inc. of Akron, Ohio. The ionizer 16 may be of any suitable construction or arrangement. For instance, the ionizer 16 may be one piece or may comprise a number of segments. Also, the ionizer may be substantially linear, curved or any other desired shape.

In the embodiment shown in FIG. 1, the ionizer 16 is mounted adjacent to a top peripheral edge or side of the windshield 12. Other appropriate locations of the ionizer 16 are possible. The ionizer 16 generates a flow of ions comprising ions of a preselected charge that flow from at least one or a plurality of electrodes 18, such as anodes and the like, associated with the ionizer 16. In some embodiments, at least one of the electrodes 18 is directed towards the windshield 12. In other embodiments, at least one of the electrodes 18 is directed away from the windshield 12. In still other embodiments, one subset of the plurality of the electrodes is directed towards the windshield 12 while a second subset of the plurality of the electrodes 18 is directed away from the windshield 12. The ions flowing from the electrodes 18 contact at least a portion of the windshield 12 such that a charge, i.e. positive or negative, identical to the charge of the ions comprising the flow of ions is imparted to at least a portion of the windshield 12.

The ionizer 16 is electrically connected to a controller 20 that controls the generation of ions. In one embodiment, the controller 20 may be a Model 1520 Pulsed DC Controller manufactured by Cole Static Control, Inc. of Akron, Ohio. The controller 20 may allow generation of either positive ions or negative ions. The controller 20 may control at least one blower, not shown for clarity, operatively associated with the windshield 12 and the ionizer 16 to allow ions to travel with movement of air from the blower. The controller 20 may allow a user to select the charge and intensity of the ions so that the user can select the charge of the ions to improve removal of particulate from the windshield 12. Alternately, the controller 20 may limit user control of the ionizer to on or off, or may limit user control to positive, negative, or off

In one embodiment, the controller 20 is connected to a power source 22. The power source 22 may be a part of a power system of the vehicle 10, or may be a separate power source, such as a battery.

In order to clear accumulated particulate from the windshield 12, the controller 20 controls the generation of ions in the ionizer 16. The ions flow from the electrodes 18 of the ionizer 16 and flow over the windshield 12. The ions generated by the ionizer 16 are of the same electrical charge, or polarity, as the particulate attached to the windshield 12, thus the particulate is repelled by the ions as a static charge on the windshield 12 is reduced by the ions from the ionizer 16. Attraction of particulate to the windshield 12 is reduced, and some particulate will be cleared from the windshield 12 by the flow of ions from the ionizer 16. A driver of the vehicle 10 may clear be able to reduce particulate on the windshield without the use of the windshield wipers, or without the use of windshield wipers in combination with windshield washing liquid. Further, the controller 20 may communicate with one or more rain sensors in order to alter or stop operation of the ionizer 16 in wet weather conditions.

In some embodiments, the controller 20 may cause the ionizer 16 to generate ions that are delivered to the windshield 12 substantially continuously. By substantially continuously delivering with ions of the same charge as the particulate to the windshield 12, adhesion of the particulate to the windshield 12 is reduced. The use of an ionizer 16 to clean particulate form the windshield 12 allows a user to remain within the vehicle while removing particulate from the windshield.

What is claimed is:

1. A windshield assembly comprising:
a windshield having a periphery; and
an ionizer disposed adjacent the periphery of the windshield, wherein the ionizer has at least one electrode that delivers ions over at least a portion of the windshield.

2. The windshield assembly of claim 1 further comprising:
a controller disposed in electrical communication with the ionizer, the controller selectively generating a signal that causes the ionizer to generate ions.

3. The windshield assembly of claim 2 further comprising:
the controller being capable of generating an on signal and an off signal to the ionizer.

4. The windshield assembly of claim 3, wherein the ionizer delivers ions having a positive charge.

5. The windshield assembly of claim 3, wherein the ionizer delivers ions having a negative charge.

6. The windshield assembly of claim 2 further comprising:
the controller being selectively capable of generating a signal causing the ionizer to produce negatively charged ions, a signal causing the ionizer to produce positively charged ions, and an off signal.

7. The windshield assembly of claim 6 further comprising:
the controller being capable of generating a signal controlling the intensity of ions produced by the ionizer.

8. The windshield assembly of claim 2 further comprising:
at least one rain sensor operatively connected to the controller, the controller conditioning the operation of the ionizer upon the absence of rain.

9. The windshield assembly of claim 1, wherein the windshield comprises safety glass.

10. The windshield assembly of claim 1, wherein the windshield comprises a polymeric material.

11. The windshield assembly of claim 1, wherein the ionizer is disposed adjacent a top side of the windshield.

12. The windshield assembly of claim 1, wherein the ionizer has a plurality of electrodes.

13. The windshield assembly of claim 12, wherein at least one of the plurality of electrodes is directed towards the windshield.

14. The windshield assembly of claim 12, wherein at least one of the plurality of electrodes is directed away from the windshield.

15. The windshield assembly of claim 1, wherein the controller is in electrical communication with a power source that powers the controller and the ionizer.

16. The windshield assembly of claim 15, wherein the power source is an electrical system of a vehicle bearing the windshield.

17. The windshield assembly of claim 1 further comprising:
a blower operatively associated with the windshield and the ionizer, the blower moving air across the windshield with ions.

18. A method of reducing particulate accumulating on a windshield of a vehicle, the method comprising:
generating ions with an ionizer having at least one electrode disposed adjacent a periphery of the windshield;
directing the ions from the ionizer to at least a portion of the windshield; and
repelling particulate adhered to at least the portion of the windshield with the ions.

19. The method of claim 18, wherein the ions have an electrical charge identical to an electrical charge of the particulate.

20. The method of claim 18 further comprising:
transmitting a control signal from a controller to the ionizer to set an electrical charge of the ions.

21. The method of claim 20, wherein the electrical charge is negative.
